(19) United States
(12) Patent Application Publication
(10) Pub. No.: US 2013/0221858 A1
(43) Pub. Date: Aug. 29, 2013

(54) AUTOMATED DISCOVERY OF A TOPOLOGY FOR LUMINAIRES

(71) Applicant: Rebecca Lynn Braynard Silberstein, Sunnyvale, CA (US)

(72) Inventor: Rebecca Lynn Braynard Silberstein, Sunnyvale, CA (US)

(73) Assignee: Palo Alto Research Center Incorporated, Palo Alto, CA (US)

(21) Appl. No.: 13/409,005

(22) Filed: Feb. 29, 2012

(51) Int. Cl. H05B 37/02

(52) U.S. Cl. 315/153

(57) ABSTRACT

An ad-hoc luminaire-controlling system communicates with nearby luminaires to identify a luminaire cluster. During operation, the system detects light patterns emitted by one or more remote luminaires, and identifies the remote luminaires from the detected light patterns. The system then identifies a luminaire cluster that includes a local luminaire and one or more of the identified remote luminaires. A central or mobile luminaire-controlling system receives a cluster description from one or more luminaires, and determines a luminaire topology based on the received cluster descriptions. Each cluster description identifies a set of luminaires that are can see each other's light. The central or mobile system can generate a state-modifying command for a set of target luminaires in a cluster based on the luminaire topology, and sends the state-modifying command to the target luminaires.

### BACKGROUND

1. Field

This disclosure is generally related to light fixtures. More specifically, this disclosure is related to luminaires that communicate using light to self-organize into clusters.

2. Related Art

Energy consumption is becoming an important social issue. As cities grow and people develop a bigger appetite for technology, their energy demand has grown at a rate that is difficult for energy providers to keep up. Energy providers oftentimes provide incentives for people to decrease how much energy they consume, especially during peak hours. During the summer season, energy providers may provide a discounted energy rate for consumers that use less than a certain level of energy during peak hours, and may increase the price for other consumers that don't curtail their peak-hour energy use.

Low-power lighting systems are gaining popularity among homeowners, businesses, and city planners as a way to reduce energy use. Advances in manufacturing of light-emitting diodes (LEDs) has allowed manufacturers to produce efficient light sources by combining a plurality of LEDs to produce a low-power white light. The main advantage of these LED light sources is that they provide a low-power light source without sacrificing brightness.

Businesses and city planners oftentimes attempt to reduce energy consumption by deploying advanced lighting systems that can be optimized to only turn on when necessary. For example, streetlights may include a light-sensitive sensor that monitors the ambient light, and turns on its light source when it begins to get dark. As another example, technicians may deploy lighting systems that can be remotely operated by a computer system. However, deploying these lighting systems requires the technician to install at each light source a controller that receives commands from the computer system, or to install a sensor that completes a circuit to power up a lighting device when it detects a moving object or a low ambient light level. The technician has to manually configure the computer system to recognize each light source, and has to program the computer system with the subroutines that control the deployed light sources in a desired manner. This causes these lighting systems to be too expensive for most consumers, because consumers would have to purchase the additional components required to operate the lighting system, and would also have to hire an experienced technician to deploy the lighting systems.

### SUMMARY

One embodiment provides an ad-hoc luminaire-controlling system that communicates with other luminaires using light to identify a luminaire cluster. The system detects light patterns emitted by one or more remote luminaires, and identifies the one or more remote luminaires from the detected light patterns. The system then identifies a luminaire cluster that includes a local luminaire and one or more of the identified remote luminaires.

In some variations on this embodiment, while identifying one of the remote luminaires, the system determines a light signature of the detected light pattern corresponding to the remote luminaire, and determines that the determined light signature is different from other determined signatures. The system then associates the determined light signature with the remote luminaire.

In some variations on this embodiment, while identifying one of the remote luminaires, the system determines a signal transmitted in the detected light pattern corresponding to the remote luminaire, and determines that the determined signal includes a unique identifier that identifies the remote luminaire.

In some embodiments, while identifying the luminaire cluster, the system identifies an initial cluster that includes the local luminaire and the identified remote luminaires. The system sends the initial cluster's description to the remote luminaires in the initial cluster, and receives a cluster description from one or more remote luminaires. The system then identifies a refined cluster that includes a plurality of luminaires that can receive direct or indirect light from each other.

In some embodiments, the system turns on the local luminaire in response to detecting a presence of an object in a vicinity of the local luminaire. The system can also send a light-activating signal to a remote luminaire in the cluster, wherein the light-activating signal causes the remote luminaire to turn on.

In some embodiments, the system turns off the local luminaire in response to determining that an object has not been detected for a certain time duration, and determining that remote luminaires in the cluster are not detecting an object.

In some embodiments, the system turns on the local luminaire in response to determining that the light pattern includes a light-activating signal from a remote luminaire in the cluster.

In some embodiments, the system communicates the luminaire cluster's description to a remote computing device that determines a luminaire topology for a plurality of luminaires. The system can also receive, from the remote computing device, a command that alters the local luminaire's operating state.

One embodiment provides a centralized or mobile luminaire-controlling system that controls a plurality of luminaires. The system can receive the cluster description from one or more luminaires, and determines a luminaire topology based on cluster descriptions received from the luminaires. Each cluster description identifies a set of luminaires that can receive light from each other (e.g., are in a line of sight from each other, or can receive light from each other that has reflected off a wall, a floor, a ceiling, or a mirror). During operation, the system can generate a state-modifying command for a target luminaire in a cluster based on the luminaire topology, and sends the state-modifying command to the target luminaire.

In some embodiments, the system generates the state-modifying command in response to at least one of: receiving an updated operating state for a luminaire; receiving a notification of an object's presence being detected by a luminaire; receiving a command from a user; and determining that a trigger condition has been satisfied.

### BRIEF DESCRIPTION OF THE FIGURES

FIG. 1 illustrates an exemplary distributed luminaire environment in accordance with an embodiment.

FIG. 2 presents a flow chart illustrating method for identifying a luminaire cluster in accordance with an embodiment.

FIG. 3 presents an exemplary flow chart illustrating a method refining a luminaire cluster in accordance with an embodiment.

FIG. 4A illustrates an exemplary luminaire placement in accordance with an embodiment.

FIG. 4B illustrates an exemplary luminaire topology in accordance with an embodiment.

FIG. 5 presents an exemplary flow chart illustrating a method for controlling one or more luminaires based on a detected presence of an object in accordance with an embodiment.

FIG. 6 presents an exemplary flow chart illustrating a method for discovering a luminaire topology in accordance with an embodiment.

FIG. 7A illustrates an exemplary streetlight environment for luminaires that automatically group into clusters in accordance with an embodiment.

FIG. 7B illustrates an exemplary luminaire topology for a set of streetlights in accordance with an embodiment.

FIG. 8 illustrates an exemplary apparatus that facilitates discovering and using a luminaire topology in accordance with an embodiment.

FIG. 9 illustrates an exemplary computer system that facilitates discovering and using a luminaire topology in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a luminaire-controlling system that solves the problem of automatically clustering luminaires (light fixtures) into local groups, and discovering a topology that describes a relative placement of neighboring clusters. For example, when a room includes multiple luminaires, these luminaires can automatically detect and identify each other, and can form a cluster that operates as a single entity. A user can configure a single switch to turn on or off all the lights in the cluster that covers the room, without having to hard-wire all the luminaires in the cluster to this switch.

Some luminaires (e.g., LED luminaires) incorporate a processor to control the light source in order to produce a high quality and consistent light. Luminaires can also include motion sensors and photodetectors that the processor uses to detect the presence of an object when determining whether to turn the individual luminaire on or off. These luminaire features can be leveraged to create a platform for controlling the behavior of multiple luminaires as a group to achieve a higher-level objective. Specifically, multiple luminaires that are installed in a room can identify each other from the light they emit, and can communicate with each other using their light source to identify a cluster that includes only luminaires that can receive light from each other.

These luminaires can use their clustering information to build a local ad-hoc network that serves as a foundation for other higher layer applications, such as lighting control or programming. These luminaires can also communicate with a central or mobile computer that determines the luminaire topology and implements a high-level application that uses the topology information to control the lights or to provide other services. Users can deploy an advanced lighting system without having to invest valuable time or money to manually network the luminaires together and configure them for their physical layout.

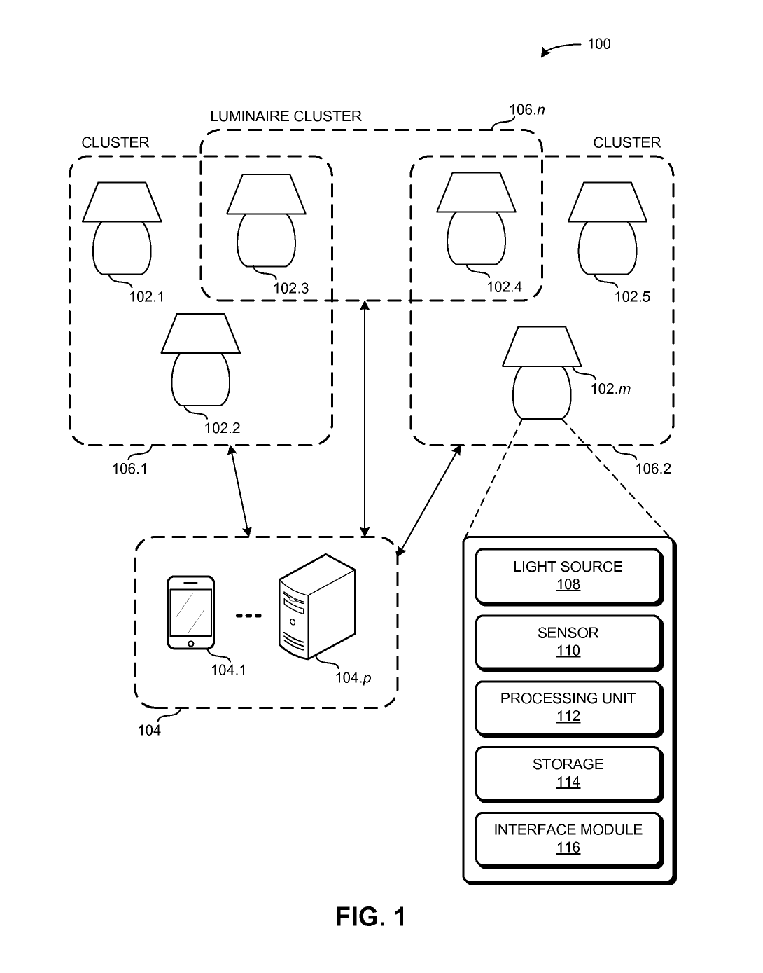

FIG. 1 illustrates an exemplary distributed luminaire environment 100 in accordance with an embodiment. Environment 100 can include a plurality of luminaires 102 and a computing device 104. Luminaires 102 have two basic functions: each luminaire can emit and detect light. This means that the luminaires can transmit information and also receive it. To transmit light or information, luminaires can include a light source 108, such as a light-emitting diode (LED) light source or any other light source that has a substantially fast response time (e.g., a time period in the order of milliseconds). To receive light or information, a luminaire can include a sensor 110. Sensor 110 can include any sensor that detects light or the presence of an object, such as a photodetector, a motion sensor, an image sensor, or an ultrasonic sensor. Luminaires can also include a processing unit 112 and a storage device 114. In some embodiments, processing unit 112 can detect the presence of an object from the information captured by sensor 110 by identifying a heat signature, detecting a motion, or extracting and identifying features from a captured image.

Light source 108 of each luminaire can emit a unique signature or an identifier, and other neighboring luminaires can detect and identify the light emitted by light source 108. For example, inherent variation in the manufacturing of LEDs causes each individual LED to have a unique light signature. Luminaires can use this unique signature to detect and identify each other. In addition to storing the determined light signatures, a luminaire's storage device 114 can store a unique identifier for the luminaire, and processing unit 112 can transmit this unique identifier by modulating the light emitted by light source 108. Even if two luminaires are not within a direct line of sight, the two luminaires can detect and identify each other from their reflected light.

Luminaires 102 can be distributed over a physical space, such as across different rooms in a house or along different streets in a city. In some embodiments, luminaires 102 can communicate with each other using light to identify local clusters 106, and to adaptively control which luminaires are turned on or off as an object moves through physical regions covered by different clusters. When one luminaire turns on, the other luminaires in its cluster can turn on in response to receiving a command from the first luminaire, or in response to detecting and identifying the light emitted by the first luminaire.

For example, in luminaire environment 100, luminaires in cluster 106.1 can detect light from each other. When luminaire 102.1 detects the presence of an object, luminaire 102.1 can turn on its light source and can cause other luminaires in its vicinity (e.g., luminaires 102.2 and 102.3) to turn on their light sources as well. Then, when the object moves into a physical region covered by luminaire 102.3, luminaire 102.3 can detect the object's presence, and can determine that it needs to stay on and communicate with other neighboring luminaires (e.g., luminaire 102.4 in clusters 106.2 and 106.n) to inform them of the object's presence. When luminaire 102.4 receives the presence notification from luminaire 102.3, luminaire 102.4 can turn on it's light source in case the object moves toward a region covered by cluster 106.2.

A luminaire can also include an interface module 116 to communicate with computing device 104 that determines a luminaire topology based on the discovered luminaire clusters. Computing device 104 can be a portable device that communicates with each luminaire using a short-distance communication medium such as modulated light waves, WiFi, Bluetooth, Ethernet, and/or any other wired or wireless communication technology now known or later developed. In some embodiments, computing device 104 can communicate with a luminaire using modulated light waves by using the device's display screen to generate the modulated light waves, and using a camera to detect modulated light waves generated by a luminaire. To gather the luminaire cluster information, a user can walk around the physical space near each of luminaires 102 while carrying computing device 104, which allows computing device 104 to gather the cluster descriptions from luminaires 102. Once computing device 104 receives the cluster descriptions from luminaires 102, computing device 104 can determine a luminaire topology that indicates the associations between pairs of luminaires and/or luminaire clusters. These associations can be due to pairs of luminaires that can detect each other's light, or due to pairs of luminaires that can detect the same objects either simultaneously or sequentially through their travel patterns.

Computing device 104 can also be a central computer system that has a persistent network connection with each of luminaires 102, such as a desktop computer or server computer. The network connection can include, for example, a wired communication channel (e.g., via Ethernet, a power line, a phone line, etc.), or a wireless communication channel (e.g., cellular, WiFi, Bluetooth, etc.). Computing device 104 can use the persistent network connection to optimize how luminaires adaptively turn on or off in a way that achieves a certain long-term goal, such as to minimize energy usage or to maximize user safety and security. Computing device 104 can gather state information from luminaires 102 over time, and can use this historical state information to optimize the luminaire topology and/or to optimize how it decides which luminaires to turn on or off. Computing device 104 can also provide high-level services that operate on the network of luminaires.

### Automatic Discovery of Luminaire Clusters and Topology

During operation, luminaires can detect and identify other nearby luminaires based on their emitted light, and can identify one or more clusters that group these luminaires. These luminaires then communicate these clusters to a computing device that determines a topology for the luminaires. This topology describes which luminaires can see each other's light (e.g., either directly or through reflected light), and hence can communicate with each other by modulating their emitted light.

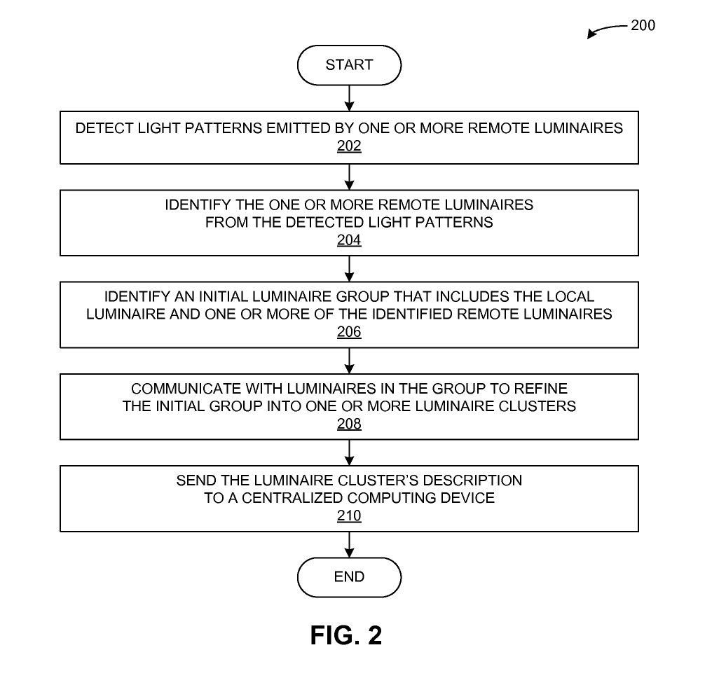

FIG. 2 presents a flow chart illustrating method 200 for identifying a luminaire cluster in accordance with an embodiment. During operation, the luminaire detects light patterns emitted by one or more remote luminaires (operation 202), and identifies the one or more remote luminaires from the detected light patterns (operation 204).

Inherent variations in the manufacturing process of certain luminaires (e.g., LED lights) causes each luminaire to emit a unique light signature, which can include a unique intensities for a variety of light frequencies. In some embodiments, the local luminaire can store a luminaire repository that stores determined light signatures for luminaires that it has detected, including the local luminaire. Further, during operation 204, the local luminaire can identify a new light pattern by identifying a light signature of the light pattern, and determining that the light signature is different from other determined signatures. The luminaire then stores the light signature in the luminaire repository to associate the light signature with the remote luminaire.

Some luminaires can transmit a unique identifier through their emitted light, for example, by modulating the emitted light to encode the unique identifier. The luminaire can also use the luminaire repository to store unique identifiers for luminaires that it has detected. Further, during operation 204, the luminaire can identify a new light pattern by determining a signal transmitted in a light pattern from a remote luminaire. If the local luminaire determines that the signal includes a unique identifier that identifies a new remote luminaire, the system stores this unique identifier in the repository to associate this identifier to the new remote luminaire.

After detecting the remote luminaires, the luminaire identifies an initial group that includes the local luminaire and one or more of the identified remote luminaires (operation 206). The luminaire can then communicate with other luminaires in the group to refine the initial group into one or more luminaire clusters (operation 208). Each luminaire cluster can include a set of luminaires that can see each other's light. The system then sends the luminaire cluster to a computing device that uses the cluster information to determine a luminaire topology (operation 210).

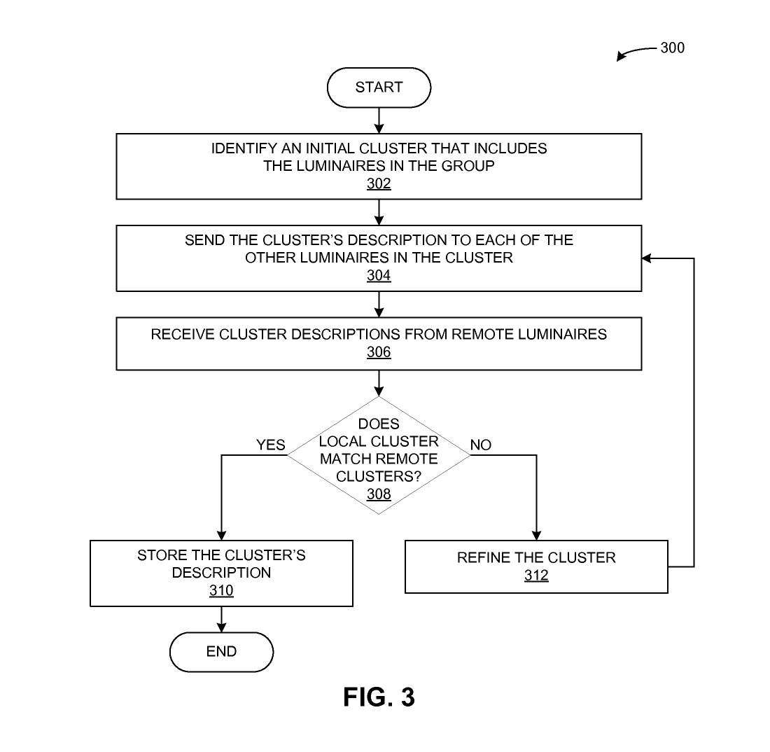

FIG. 3 presents an exemplary flow chart illustrating a method 300 for refining a luminaire cluster in accordance with an embodiment. During operation, the local luminaire identifies an initial cluster that includes the luminaires in the group (operation 302), and sends the cluster description to each of the other luminaires in the group (operation 304). The luminaire also receives cluster descriptions from other luminaires (operation 306). The luminaire then determines whether the local cluster matches those received from other luminaires (operation 308). If so, the local luminaire can store the cluster (operation 310). Otherwise, the luminaire can refine the cluster to include a group of luminaires that can receive a light-of-sight light from each other (operation 312), and returns to operation 304 to send the refined cluster to each of the other luminaires in the refined cluster.

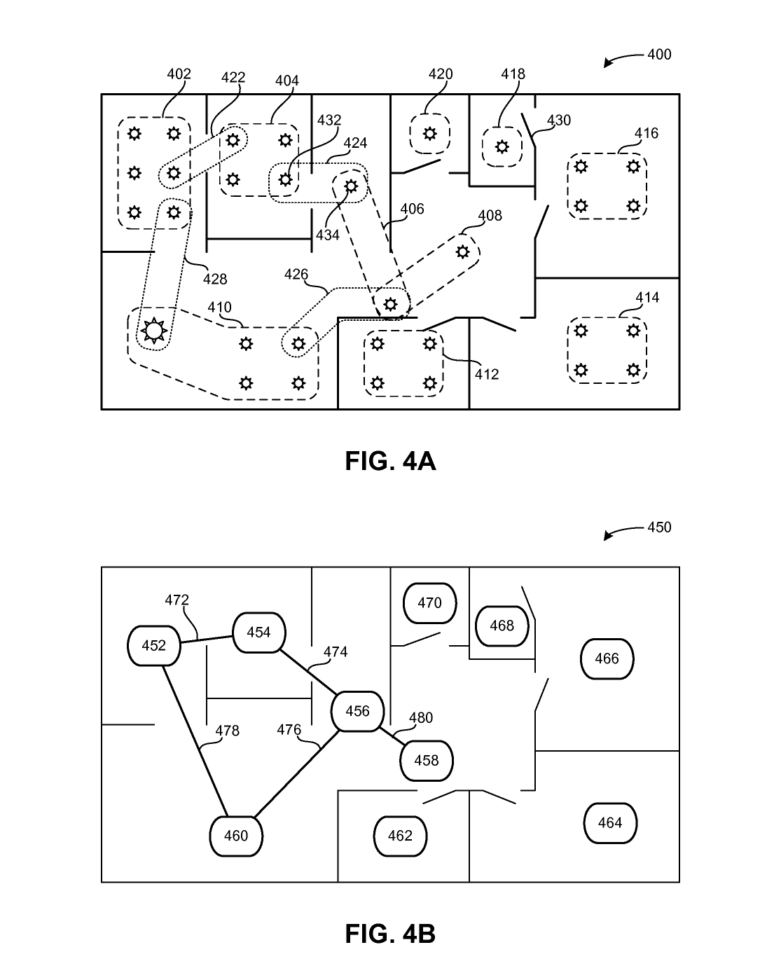

FIG. 4A illustrates an exemplary luminaire placement 400 in accordance with an embodiment. Luminaire placement 400 can correspond to a plurality of luminaires that are distributed across a home or an office. When the luminaires are installed, they can cluster themselves into groups of luminaires that are within the same room or across a doorway from each other. For example, clusters 402 and 404 can correspond to two adjacent conference rooms, and cluster 422 can include luminaires along a doorway that unites both conference rooms. Cluster 410 can correspond to a lobby or reception area, and cluster 428 can form across a doorway that connects the lobby to the first conference room. Also, cluster 408 can form from several luminaires within a break room.

To refine the cluster (e.g., during operation 312), a luminaire can compare the local cluster with those received from other nearby luminaires to determine how these clusters overlap (e.g., discover which groups of luminaires can see each other's light). For example, luminaire 432 can have an initial cluster that includes the luminaires illustrated in regions 404 and 406. However, after receiving the initial cluster from the surrounding luminaires, luminaire 432 determines that the other luminaires in the conference room (cluster 404) cannot see light emitted by luminaire 434. In response, luminaire 432 identifies cluster 404 for the conference room, and identifies cluster 424 that corresponds to the doorway toward luminaire 434.

Because the lobby, conference rooms, and break area are high-traffic areas, the user (e.g., a lighting technician) may configure certain clusters to turn on in anticipation of a person entering a room. For this reason, the user may decide to allow clusters in these regions to be interconnected with other clusters in the topology. This allows luminaires in one cluster to communicate with luminaires in a cluster for a different region. Specifically, the user may allow clusters 406, 424, 426, and 428 to form so that luminaires can communicate across the hallways or doorways that connect the high-traffic areas to each other.

Clusters 412, 414, 416 can form from luminaires within different cubicle areas, and clusters 418 and 420 can each form from a single luminaire within a restroom. These regions of the office space are not open high-traffic areas, and so the lighting specialist may not want a person walking in one room to cause the lights to turn on in a neighboring room. It may not be very often that a person walking across a cubicle or break room area will enter a restroom, or will need the restroom light to turn on before he enters the restroom. Also, a person that is working late at night may stay in the cubicle area for an extended period of time, so he may not need the break room lights to turn on every time he moves around within the cubicle area. For these reasons, the user may configure the luminaires clusters in the restrooms or cubicle areas to be isolated from all other clusters. The user can achieve this isolated cluster configuration by simply closing the doorways to these rooms (e.g., doorway 430) when configuring the luminaires in the room to group into local clusters. Alternatively, the system can identify the clusters based on the user's behavior, for example, to remove luminaires from a cluster that do not detect the presence or travel patterns of the same objects.

In some embodiments, if the luminaires do form an undesired cluster, the user can interact with the central or mobile computing device to delete a cluster from the luminaire topology. The computing device can use the cluster information to determine a topology for the luminaires in the office space. The user can interact with the computing device, such as a mobile device, to remove an undesired cluster, or to remove luminaires from a cluster.

FIG. 4B illustrates an exemplary luminaire topology 450 in accordance with an embodiment. Luminaire topology 450 can include a node for each cluster in the office space, and can include an edge for each pair of clusters whose luminaires are allowed to interact with each other. The system can generate an edge when two neighboring clusters share at least one luminaire, or when a cluster that overlaps two clusters is collapsed into an edge. The system can collapse a cluster into an edge when it detects that all luminaires in the cluster are covered by neighboring clusters. Alternatively, the system can collapse the cluster into an edge when the user indicates that the cluster is to be collapsed.

Specifically, nodes 452 and 454 can correspond to conference room clusters 402 and 404, such that nodes 452 and 454 are coupled by an edge 472 that forms based on doorway cluster 422. Similarly, the system can generate edges 474, 476, and 478 by collapsing clusters 424, 426, and 428. The system can also generate an edge 480 that couples topology nodes 456 and 458 when it determines that clusters 406 and 408 share at least one luminaire.

Nodes 462, 464, 466, 468, and 470 in topology 450 correspond to isolated clusters, and may not be coupled to other nodes by an edge.

### Ad-Hoc Luminaire Control

In some embodiments, a plurality of luminaires can use the cluster definitions to optimize the lighting configuration using ad-hoc communication. Recall that each individual luminaire can belong to one or more clusters, and can use these cluster definitions to determine which other luminaires it needs to communicate with. For example, a cluster can include a group of luminaires within a room, and the luminaires in the room can use the cluster definition to activate or deactivate all the lights using ad-hoc communication. A luminaire can activate a light by turning on the light from an “off” state, or by increasing the light intensity from a “low-energy” state. A luminaire can deactivate a light source by turning off the light completely, or by decreasing the light intensity from an “on” state to the “low-energy” state or any other light intensity.

When one luminaire in the cluster detects a moving object (e.g., a person entering through a doorway), this luminaire can activate its local light source, and can send a command to the other luminaires in the room to cause them to turn on. Or if another luminaire detects a moving object, the local luminaire can receive a light-activating command, and can activate the local light source in response to receiving the command even if the local luminaire does not detect the presence of an object. Each luminaire in the cluster can deactivate its local light source when it determines that none of the luminaires in the room have detected an object's presence for a determinable time duration (e.g., it has not detected the object's presence or received a light-activating command from a remote luminaire).

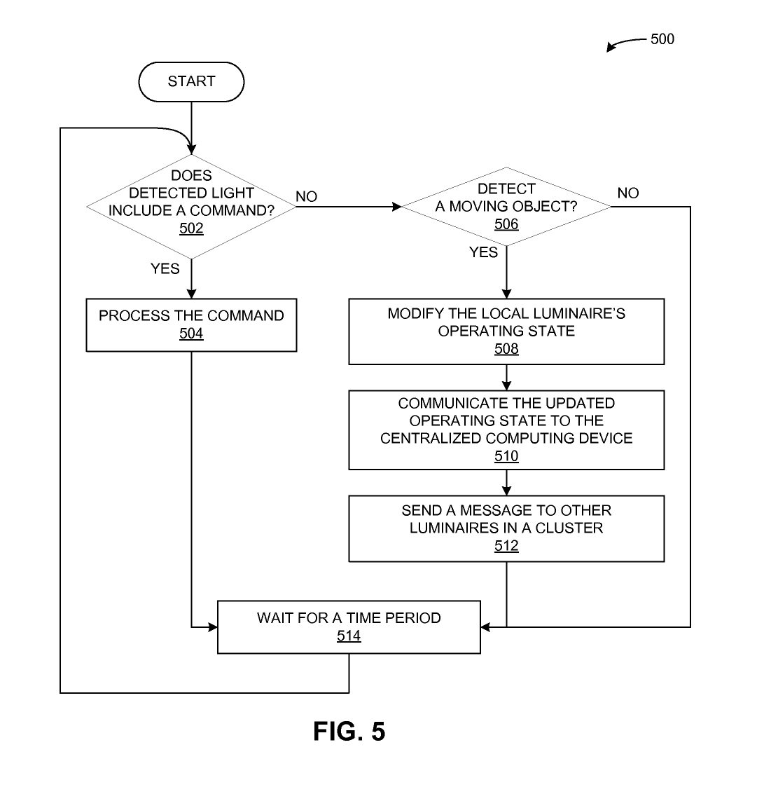

FIG. 5 presents an exemplary flow chart illustrating a method 500 for controlling one or more luminaires based on a detected presence of an object in accordance with an embodiment. During operation, the local luminaire can periodically determine whether the detected light pattern includes a command (operation 502). If so, the luminaire can process the command (operation 504). The luminaire may receive the command from a remote luminaire, or form the user's portable device that communicates with the luminaire via modulated light waves. The command may turn the luminaire's light source either on or off, set the luminaire's light source to a “low-power” energy state, or set the luminaire's light source to a specific intensity level. In some other embodiments, the local luminaire can receive a command that modifies the luminaire's configuration, such as by modifying it's cluster memberships, or by modifying the list of luminaires that it shares a cluster with.

If the luminaire does not receive a command, the luminaire can determine whether it detects a moving object (operation 506). If so, the luminaire can modify the local luminaire's operating state (operation 508). In some embodiments, the luminaire can optionally communicate the updated operating state to the computing device (operation 510). The luminaire can also send a message to other luminaires in a cluster (operation 512). This message can inform the other luminaires of the local luminaire's updated operating state, can inform the other luminaires of the detected object's speed and direction, and/or can include a command that modifies the operating state for the other luminaires. After performing operation 504, 506, or 514, the luminaire may wait for a determinable time period (operation 514), and returns to operation 502 to check for another event.

### Luminaire-Controlling System

In some embodiments, the luminaire-controlling system can be a central or mobile computing device that determines the luminaire topology from the luminaire clusters, which models how these clusters are arranged alongside each other. The system can also use the luminaire topology to determine how to control the operating states of the luminaires.

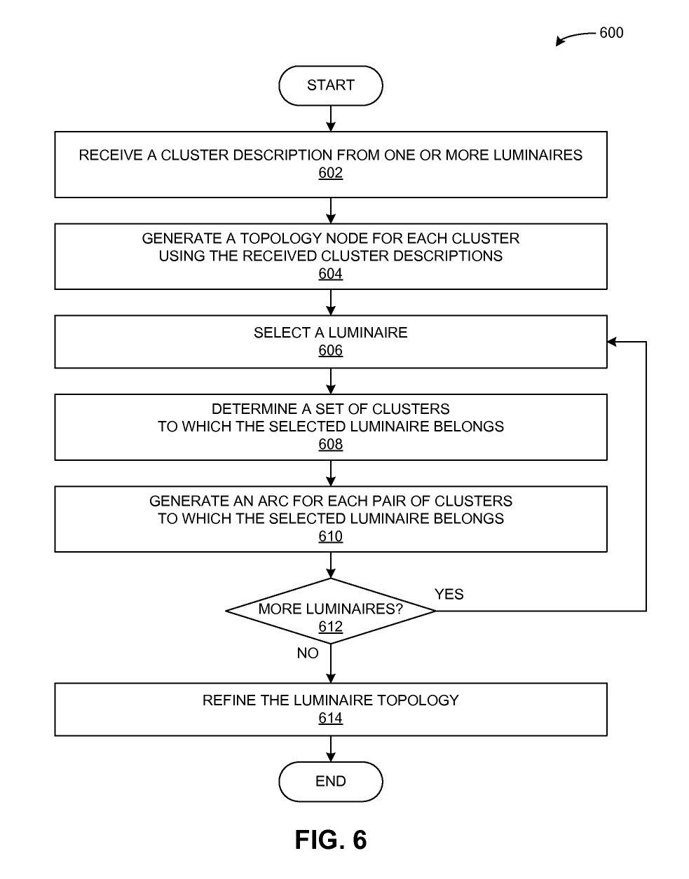

FIG. 6 presents an exemplary flow chart illustrating a method 600 for discovering a luminaire topology in accordance with an embodiment. During operation, the system can receive a cluster description from one or more luminaires (operation 602), such that each cluster description identifies a set of luminaires that can see each other's light. The system uses the received cluster descriptions to generate a topology node for each cluster (operation 604). The system then generates an edge between clusters that have at least one luminaire in common.

To generate the edges of the luminaire topology, the system selects a luminaire (operation 606), and determines a set of clusters to which the selected luminaire belongs (operation 608). The system generates an edge for each pair of clusters to which the selected luminaire belongs (operation 610). The system then determines whether there are more luminaires to select from (operation 612). If so, the system returns to operation 606 to select another luminaire. Otherwise, the system proceeds to refine the luminaire topology (operation 614).

The initial luminaire topology can include an undesirably large number of clusters, or some clusters may include some undesired luminaires. In some embodiments, the system can present a user interface that illustrates the luminaire topology to a user, and allows the user to refine the luminaire topology. The system can receive modifications to the luminaire topology from the user, for example, to remove a cluster or remove a luminaire from a cluster. If the user elects to remove a luminaire from a cluster, the system can remove the luminaire from the indicated cluster while preserving the luminaire's membership to other clusters of the luminaire topology. If the user elects to remove a cluster, the system can collapse the cluster into an edge of the luminaire topology. For example, if the user elects to remove clusters 422, 424, 426, and 428 (see FIG. 4A), the system can generate an edge in the topology for each of these clusters (e.g., edges 472, 474, 476, and 478 of FIG. 4B).

In some embodiments, the system can monitor and store historical state information for the luminaires over time, and can use this historical information to refine the luminaire topology at runtime. The historical information can include the time intervals during which each luminaire detects a moving object. The system can use this historical information to determine which pairs of luminaires are neighbors along a path, and to model outbound-trajectory probabilities for each luminaire.

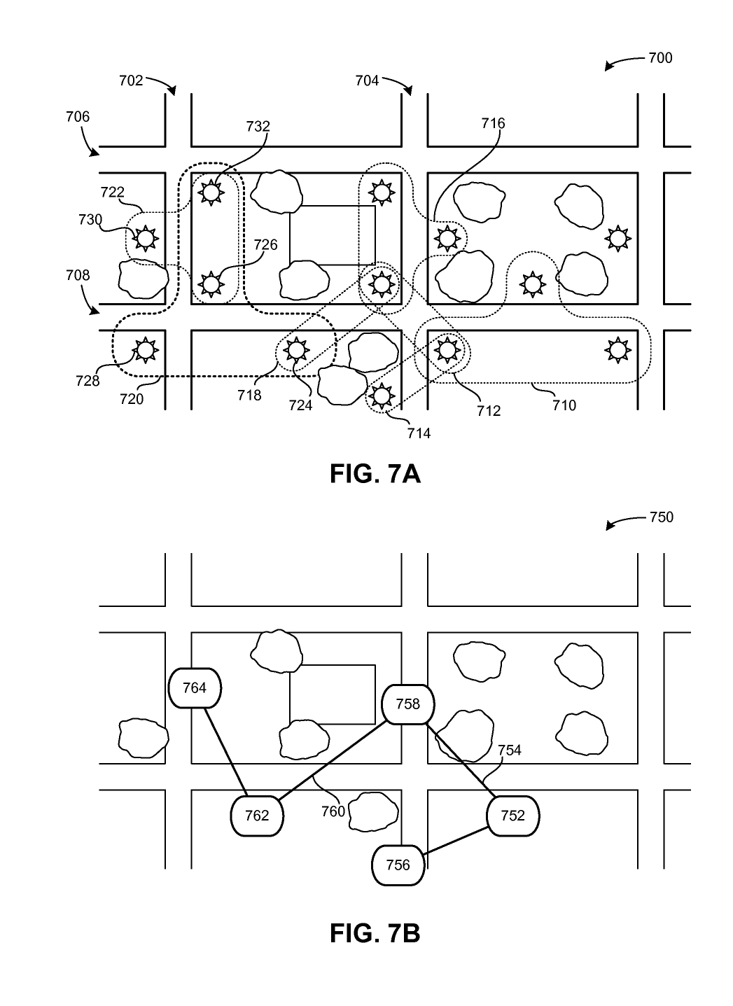

FIG. 7A illustrates an exemplary streetlight environment 700 for luminaires that automatically group into clusters in accordance with an embodiment. Environment 700 can include streets 702 and 704 that carry traffic in the northbound and southbound directions, and can include streets 706 and 708 that carry traffic in the eastbound and westbound directions. Environment 700 can also include luminaires that group into clusters 710, 712, 714, 716, 718, 720, and 722, such that each cluster includes a group of luminaires that can see each other's light.

The system can use the historical information to determine, when a moving object reaches a certain luminaire, to which other luminaires the moving object may approach next. The system can model outbound-trajectory probabilities for a luminaire by computing, for each neighboring luminaire as an inbound trajectory, a probability that each of the other luminaires will detect the moving object next as an outbound trajectory. For example, with respect to luminaire 726, the system can determine the probabilities listed in Table 1.

TABLE 1

| Destination: | Lum. 724 | Lum. 728 | Lum. 730 | Lum. 732 |
|---|---|---|---|---|
| Source: 724 | 0.08 | 0.75 | 0.25 | 0.003 |
| Source: 728 | 0.75 | 0.07 | 0.25 | 0.002 |
| Source: 730 | 0.25 | 0.25 | 0.1 | 0.003 |

Table 1 presents outbound-trajectory probabilities for nearby luminaires that can communicate with luminaire 726 using light in accordance with an embodiment. In table 1, the rows correspond to the luminaires that detected a moving object prior to luminaire 726 detecting the object (the sources). The columns correspond to the luminaires that may detect the object after it moves past luminaire 726 (the destinations). For example, if luminaire 726 detects a moving object and it determines that luminaire 724 detected the object first, then luminaire 726 can determine that the object is moving westbound along street 708. Using table 1, luminaire 726 can determine that the object will continue to move westbound (toward luminaire 728) with a probability of 0.75, or may make a right turn (toward luminaire 730) with a probability of 0.25.

The system can augment the luminaire topology so that a luminaire in the topology is assigned a corresponding set of outbound-trajectory probabilities for each of its neighboring nodes. The system can also communicate, to each individual luminaire, its corresponding set of outbound-trajectory probabilities. Providing these probabilities to the individual luminaires allows the luminaires to determine which neighboring luminaires it needs to inform of a moving object. For example, because luminaire 732 does not cover a region adjacent to that of cluster 720 (e.g., luminaires 724, 726, or 728), the other luminaires in cluster 720 don't need to inform luminaire 732 of a detected moving object.

In some embodiments, the system can refine a cluster to remove a luminaire that does not cover a physical region that is adjacent to any other luminaire in a cluster, such as to remove luminaire 732 from cluster 120. At runtime, the system can use the outbound-trajectory probabilities to determine which luminaires may experience a moving object next, and to determine whether a luminaire in a cluster may not be recognized as a likely outbound-trajectory by any other luminaires in the cluster. When the system determines that a luminaire does not experience presence or motion behavior patterns that coincide with those of other luminaires in a cluster, the system can remove this mismatched luminaire from the cluster.

Notice that Table 1 indicates that when luminaire 726 detects a moving object, the probability of the object advancing to luminaire 732 is negligibly small (0.003). This is because the presence-detecting sensors for luminaires 726 and 732 may not cover adjacent regions, even though luminaires 726 and 732 can detect each other's light. Luminaire 732 may be facing a different street (e.g., street 706), and does not detect the same moving objects as the other luminaires in cluster 720. So luminaire 732 may not need to communicate with the other luminaires of cluster 720. This determination allows the system to remove luminaire 732 from cluster 720 to produce a pruned down cluster that includes luminaires that need to communicate with each other.

The refined clusters allow the system to simultaneously turn on all lights of a cluster when any one of the lights detects a moving object, without turning on any lights that may not be seen by the moving object. Either the luminaire-controlling system can send a command to all luminaires in the cluster, or the luminaires in the cluster can communicate only with the other luminaires in the cluster while ignoring other nearby luminaires that they don't share a cluster with.

In some embodiments, the system can automatically collapse one or more unnecessary clusters into edges. During operation 612, the system can select a cluster whose luminaires are also members of other clusters. If this cluster overlaps two other clusters, the system can replace the selected cluster with an edge that couples the two other clusters. For the example illustrated in FIG. 7A, the system can determine that cluster 712 can be collapsed into an edge 762 that couples clusters 760 and 766. Also, the system can determine that cluster 718 can be collapsed into an edge 768.

FIG. 7B illustrates an exemplary luminaire topology 750 for a set of streetlights in accordance with an embodiment. Luminaires topology 750 includes clusters 752, 756, 758, 762, and 764, and each of these clusters includes a group of luminaires from environment 700 that can see each other's light. The edges that couple two clusters are generated either from a luminaire that is a member of the two adjacent clusters, or from a cluster that was collapsed into an edge. Specifically, clusters 752 and 756 are coupled by an edge because they correspond to adjacent clusters 710 and 714 of FIG. 7A. Cluster 712 of FIG. 7A is collapsed into edge 754, which is used to couple cluster 758 to cluster 752. Similarly, cluster 718 of FIG. 7A is collapsed into edge 760, which is used to couple cluster 762 to cluster 758.

### Exemplary Applications

The ad-hoc network of luminaires can interact with each other and/or the computer system to implement applications that leverages the luminaire framework to achieve a system-wide goal. These applications can provide convenience to users, for example, by monitoring user behavior over time and predicting how the system can best be configured for the user. These applications can also provide value to users, for example, by optimizing the operating state of luminaires to provide a desired utility while consuming a minimum amount of energy. Some exemplary applications are described below.

Synchronized Light Activation:

In some embodiments, the central or mobile computing device can send a state-modifying command to a set of target luminaires in a cluster based on the luminaire topology. For example, a user may wish to turn on all lights in a room using a single light switch, or in response to a certain event. The user can assign one or more clusters to a switch (e.g., a physical switch in the house or to a switch displayed on a portable device) or to a software trigger. The trigger event can include a luminaire detecting the presence of an object (e.g., from a motion or sound from the object), the luminaire not detecting the presence of the object for a predetermined amount of time, a timer function, or any other trigger condition or event. The system can generate the state-modifying command to turn on or off all luminaires in the selected clusters when a user toggles the switch or when the trigger event occurs.

Adaptive Street Lighting:

In some embodiments, each luminaire of an outdoor region is associated with a corresponding coverage area, and can compute an object's velocity from the time duration that it detects the object. For example, if the luminaire's coverage area has a diameter of x feet and the luminaire detects a moving object for a time duration of t seconds, the luminaire can determine the object's velocity using:

v=x/t (1)

When a luminaire sends a presence-detection signal to its neighboring luminaires to inform them of the detected object, the luminaire can also send the computed velocity to the other luminaires in its cluster so that they can determine how far to propagate the presence-detection signal. If the local luminaire detects a bicycle, the target luminaire that receives the presence detection notification may not propagate the notification to distant luminaires until the target luminaire detects the bicycle. However, if the local luminaire detects a police car traveling at 65 miles per hour, the target luminaire may determine that it needs to propagate the presence-detection signal to other luminaires along the car's probable trajectories to ensure that the driver can see far-away landmarks or road hazards.

In some embodiments, the local luminaire can send the computed velocity information to a central or mobile computing device that stores historical presence-detection information. The computing device can use the detected presence and/or the computed velocity to determine which luminaires need to be activated to ensure the object's visible paths are well lit. For example, the system can determine when each luminaire along it's path needs to be activated, and how long of a path needs to be lit to allow the moving object to foresee landmarks or hazards. The system can synchronize the lighting of a sequence of luminaires to correspond to the object's possible trajectories. The system can activate a number of lights in its forward trajectory, and can activate lights around corners as the moving object approaches an intersection.

Energy Management:

In some embodiments, each luminaire in a cluster keeps track of how much energy it is using at any given time, and each luminaire can optimize its local operation to minimize energy usage for the system as a whole. At any given time during an “on” state for the cluster, a subset of the luminaires in the cluster may be turned on to light up the room to a desired brightness. The luminaires in the cluster can communicate with each other the amount of energy that each is consuming, and the most power-efficient luminaires obtain priority over the lesser power-efficient luminaires. The luminaires that are turned not on can monitor the active (“on”) luminaires to determine their current energy efficiency, and to determine whether any active luminaire turns off. These stand-by luminaires can take the place of any luminaire that turns off due to a failure event, or that becomes less efficient over time due to wear.

Luminaire Maintenance:

Since luminaires continually monitor their neighbors, a luminaire can detect the quality of light from its neighbors, and can report a change in a luminaire's light quality (e.g., a degrading light intensity or a failing luminaire) to other nearby luminaires and/or the computing device. If the central or mobile computing device receives a notification of a degraded or failing luminaire, the central computing device can modify the operating state of other nearby luminaires to compensate for the degraded light intensity in its local region. For example, the computing device can cause other nearby luminaires to turn on, or to increase their light intensity. Alternatively, the neighboring luminaires can automatically turn on or increase their light intensity to compensate for the failing or degraded luminaire without having to receive a command from the computing device.

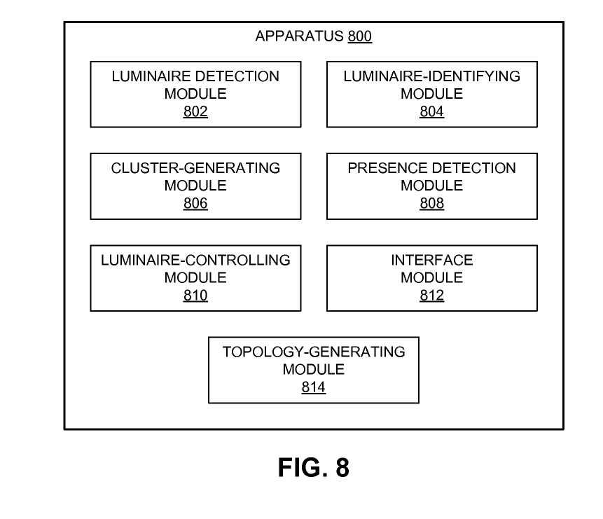

FIG. 8 illustrates an exemplary apparatus 800 that facilitates discovering and using a luminaire topology in accordance with an embodiment. Apparatus 800 can comprise a plurality of modules, which may communicate with one another via a wired or wireless communication channel. Apparatus 800 may be realized using one or more integrated circuits, and may include fewer or more modules than those shown in FIG. 8. Further, apparatus 800 may be integrated in a computer system, or realized as a separate device that is capable of communicating with other computer systems and/or devices. Specifically, apparatus 800 can comprise a luminaire-detection module 802, a luminaire-identifying module 804, a cluster-identifying module 806, a presence-detection module 808, a luminaire-controlling module 810, an interfacing module 812, and a topology-determining module 814.

In some embodiments, luminaire-detection module 802 can detect light patterns emitted by one or more remote luminaires. Luminaire-identifying module 804 can identify the one or more remote luminaires from the detected light patterns. Cluster-identifying module 806 can identify a luminaire cluster that includes a local luminaire and one or more of the identified remote luminaires. Presence-detection module 808 can detect a presence of an object within a certain proximity of the local luminaire. Luminaire-controlling module 810 can activate the local luminaire in response to a detected presence. Interfacing module 812 can send or receive a light-activating signal to or from a remote luminaire in the cluster. Topology-determining module 814 can determine a luminaire topology based on cluster descriptions received from one or more luminaires.

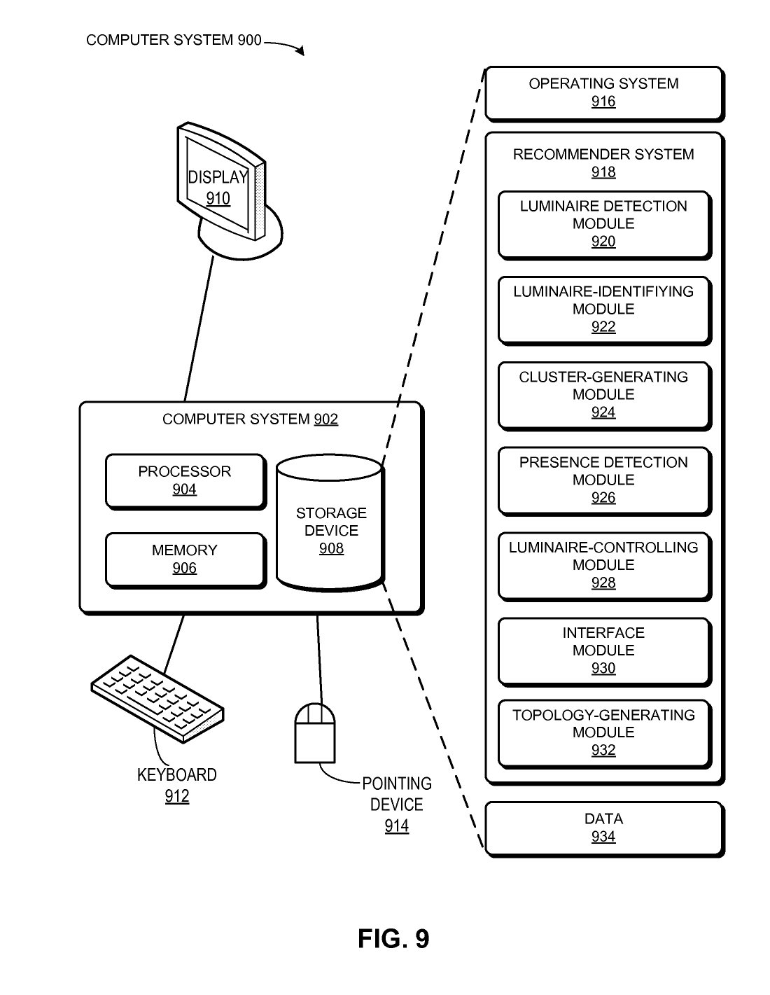

FIG. 9 illustrates an exemplary computer system 902 that facilitates discovering and using a luminaire topology in accordance with an embodiment. Computer system 902 includes a processor 904, a memory 906, and a storage device 908. Memory 906 can include a volatile memory (e.g., RAM) that serves as a managed memory, and can be used to store one or more memory pools. Furthermore, computer system 902 can be coupled to a display device 910, a keyboard 912, and a pointing device 914. Storage device 908 can store operating system 916, a luminaire-controlling system 918, and data 934.

Luminaire-controlling system 918 can include instructions, which when executed by computer system 902, can cause computer system 902 to perform methods and/or processes described in this disclosure. Specifically, luminaire-controlling system 918 may include instructions for detecting light patterns emitted by one or more remote luminaires (luminaire-detection module 920), and for identifying the one or more remote luminaires from the detected light patterns (luminaire-identifying module 922). Luminaire-controlling system 918 can also include instructions for identifying a luminaire cluster that includes a local luminaire and one or more of the identified remote luminaires (cluster-identifying module 924).

Luminaire-controlling system 918 can include instructions for detecting a presence of an object within a certain proximity of the local luminaire (presence-detection module 926), and for activating the local luminaire in response to a detected presence (luminaire-controlling module 928). Luminaire-controlling system 918 can include instructions for sending or receiving a light-activating signal to or from a remote luminaire in the cluster (interface module 930). Luminaire-controlling system 918 can also include instructions for determining a luminaire topology based on cluster descriptions received from one or more luminaires (topology-determining module 932).

Data 934 can include any data that is required as input or that is generated as output by the methods and/or processes described in this disclosure. Specifically, data 934 can store at least a light signature or unique identifier of a remote luminaire, a luminaire cluster definition, a luminaire topology definition, an operating state for one or more luminaires.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method, comprising:
detecting, by a luminaire-controlling device, light patterns emitted by one or more remote luminaires;
identifying the one or more remote luminaires from the detected light patterns; and
identifying a luminaire cluster that includes a local luminaire and one or more of the identified remote luminaires that can detect each other's light patterns.

2. The method of claim 1, wherein identifying one of the remote luminaires involves:
determining a light signature of the detected light pattern corresponding to the remote luminaire;
determining that the determined light signature is different from other determined signatures; and
associating the determined light signature with the remote luminaire.

3. The method of claim 1, wherein identifying one of the remote luminaires involves:
determining a signal transmitted in the detected light pattern corresponding to the remote luminaire; and
determining, from the determined signal, a unique identifier that identifies the remote luminaire.

4. The method of claim 1, wherein identifying the luminaire cluster involves:
identifying an initial cluster that includes the local luminaire and the identified remote luminaires;
sending the initial cluster's description to the remote luminaires in the initial cluster;
receiving a cluster description from one or more remote luminaires; and
identifying a refined cluster that includes a plurality of luminaires that can detectlight patterns from each other.

5. The method of claim 1, further comprising:
detecting a presence of an object in a vicinity of the local luminaire;
activating the local luminaire; and
sending a light-activating signal to a remote luminaire in the cluster, wherein the light-activating signal causes the remote luminaire to activate.

6. The method of claim 5, further comprising:
determining that an object's presence has not been detected for a time duration;
determining that the remote luminaires in the cluster are not detecting a presence of an object; and
deactivating the local luminaire.

7. The method of claim 1, further comprising:
determining that the light pattern includes a light-activating signal from a remote luminaire in the cluster; and
activating the local luminaire.

8. The method of claim 1, further comprising:
communicating the luminaire cluster's description to a remote computing device that determines a luminaire topology for a plurality of luminaires; and
receiving, from the remote computing device, a command that alters the local luminaire's operating state.

9. A computer-implemented method, comprising:
receiving, by a computing device, a cluster description from one or more luminaires, wherein the cluster description identifies a set of luminaires that each other's light patterns;
determining a luminaire topology based on cluster descriptions received from the one or more luminaires;
generating a state-modifying command for a target luminaire in a cluster based on the luminaire topology; and
sending the state-modifying command to the target luminaire.

10. The method of claim 9, wherein generating the state-modifying command is in response to at least one of:
receiving an updated operating state for a luminaire;
receiving a notification of an object's presence detected by a luminaire;
receiving a command from a user; and
determining that a trigger condition has been satisfied.

11. An apparatus, comprising:
a luminaire-detection module to detect light patterns emitted by one or more remote luminaires;
a luminaire-identifying module to identify the one or more remote luminaires from the detected light patterns; and
a cluster-identifying module to identify a luminaire cluster that includes a local luminaire and one or more of the identified remote luminaires that can detect each other's light patterns.

12. The apparatus of claim 11, wherein while identifying one of the remote luminaires, the luminaire-identifying module is further configured to:
determining a light signature of the detected light pattern corresponding to the remote luminaire;
determine that the determined light signature is different from other determined signatures; and
associate the determined light signature with the remote luminaire.

13. The apparatus of claim 11, wherein while identifying a remote luminaire, the luminaire-identifying module is further configured to:
determine a signal transmitted in the detected light pattern corresponding to the remote luminaire; and
determine, from the determined signal, a unique identifier that identifies the remote luminaire.

14. The apparatus of claim 11, wherein while identifying the luminaire cluster, the cluster-identifying module is further configured to:
identify an initial cluster that includes the local luminaire and the identified remote luminaires;
send the initial cluster's description to the remote luminaires in the initial cluster;
receive a cluster description from one or more remote luminaires; and
identify a refined cluster that includes a plurality of luminaires that can detect light patterns from each other.

15. The apparatus of claim 11, further comprising:
a presence-detection module to detect a presence of an object in a vicinity of the local luminaire;
a luminaire-controlling module to activate the local luminaire; and
an interfacing module to send a light-activating signal to a remote luminaire in the cluster, wherein the light-activating signal causes the remote luminaire to activate.

16. The apparatus of claim 15, wherein the presence-detection module is further configured to determine that an object's presence has not been detected for a time duration;
wherein the interfacing module is further configured to determine that the remote luminaires in the cluster are not detecting a presence of an object; and
wherein the luminaire-controlling module is further configured to deactivate the local luminaire.

17. The apparatus of claim 11, wherein the interfacing module is further configured to determine that the light pattern includes a light-activating signal from a remote luminaire in the cluster; and
wherein the luminaire-controlling module is further configured to activate the local luminaire.

18. The apparatus of claim 11, wherein the interfacing module is further configured to:
communicate the luminaire cluster's description to a remote computing device that determines a luminaire topology for a plurality of luminaires; and
receive, from the remote computing device, a command that alters the local luminaire's operating state.

19. A non-transitory computer-readable storage medium storing instructions that when executed by a computer cause the computer to perform a method, the method comprising:
receiving, by a computing device, a cluster description from one or more luminaires, wherein the cluster description identifies a set of luminaires that can detect each other's light patterns;
determining a luminaire topology based on cluster descriptions received from the one or more luminaires;
generating a state-modifying command for a target luminaire in a cluster based on the luminaire topology; and
sending the state-modifying command to the target luminaire.

20. The method of claim 19, wherein generating the state-modifying command is in response to at least one of:
receiving an updated operating state for a luminaire;
receiving a notification of an object's presence detected by a luminaire;
receiving a command from a user; and
determining that a trigger condition has been satisfied.
